(19) United States
(12) Patent Application Publication
(10) Pub. No.: US 2020/0084255 A1
(43) Pub. Date: Mar. 12, 2020

(54) Dynamic Prediction Techniques for Interactive Content Streaming

(71) Applicant: LiquidSky Software, Inc., New York, NY (US)

(72) Inventors: Ian McLoughlin, New York, NY (US); Timothy Miller, Great Falls, VA (US)

(21) Appl. No.: 16/561,663

(22) Filed: Sep. 5, 2019

Related U.S. Application Data
(60) Provisional application No. 62/728,049, filed on Sep. 6, 2018.

(51) Int. Cl. H04L 29/06; H04L 29/08; G06N 3/08

(52) U.S. Cl. CPC H04L 65/80; H04L 65/60; G06F 3/04842; H04L 65/1066; G06N 3/08; H04L 67/306

(57) ABSTRACT

Systems and techniques are disclosed for predicting user actions to be performed in a subsequent streaming session and pre-rendering frames corresponding to the predicted user actions, and thereby classified as likely to be displayed in the subsequent streaming session. In some implementations, account data indicating a set of user actions performed during prior streaming sessions of an application of a computing device is obtained. The account data is provided to a model trained to output, for each of different sets of user actions, predicted user actions classified as likely being performed in a subsequent streaming session of the application on the computing device. A particular set of user actions classified as likely being performed during the subsequent streaming session is received. A set of frames likely to be rendered during the subsequent streaming session is identified and provided to the computing device before the subsequent streaming session.

### CROSS-REFERENCE TO RELATED APPLICATIONS

This application claims priority to U.S. Application Ser. No. 62/728,049, filed on Sep. 6, 2018, which is incorporated by reference in its entirety.

### FIELD

The present specification generally relates to computer systems, and more particularly relates to virtual computing environments.

### BACKGROUND

Remote computing systems can enable users to remotely access hosted resources. Servers on remote computing systems can execute programs and transmit signals for providing a user interface on client devices that establish communications with the servers over a network. The network may conform to communication protocols such as the TCP/IP protocol. Each connected client device may be provided with a remote presentation session such as an execution environment that provides a set of resources. Each client can transmit data indicative of user input to the server, and in response, the server can apply the user input to the appropriate session. The client devices may use remote streaming and/or presentation protocols such as the remote desktop protocol (RDP) or remote frame buffer protocol (RFB) to remotely access resources provided by the server.

Hardware virtualization refers to the creation of a virtual machine that remotely access resources of a server computer with an operating system. Software executed on these virtual machines can separated from the underlying hardware resources. In such arrangements, a host system refers to the physical computer on which virtualization takes place, and client devices that remotely accesses resources of the host system are referred to as computing devices. Hardware virtualization may include full virtualization, where complete simulation of actual hardware is allowed to run unmodified, partial virtualization, where some but not all of the target environment attributes are simulated, and paravirtualization, where a hardware environment is not simulated but some guest programs are executed in their own isolated domains as they are running on a separate system.

### SUMMARY

Interactive content streaming systems enable a user to run virtual instances of applications that are installed on another device. For instance, a virtual instance of an application that is installed on a host system, such as a server, may be run on a client device connected to the host system over a network to enable the client device to stream content from the host system.

The streaming performance of interactive content streaming systems can depend on certain network conditions that produce latency. For example, latency perceptible by a user can reduce the interactivity of content being streamed to a computing device of the user. In such circumstances, many interactive content streaming respond to network conditions and/or device input data by performing certain actions. For example, an interactive content streaming system can reduce the resolution of video streamed to a client device if network bandwidth becomes limited during streaming. While these techniques can provide responsive improvements in streaming performance, they do not proactively prevent network conditions that cause reductions in performance to begin with. These techniques are therefore address performance degradation upon detection rather sufficiently prevent performance degradation during a streaming session.

To address this and other limitations of interactive content streaming systems, the system disclosed herein is capable of using techniques to predict how certain historical conditions, e.g., a user input, network traffic conditions, allocated computing resources, or device/sensor output, will impact performance in subsequent streaming sessions. The system can use the predictions to perform designated actions prior to occurrence of the conditions so that the likelihood that performance degradation, such as latency, occurs during a subsequent streaming session is reduced.

As an example, the system disclosed herein can predict a set of possible inputs to be provided by a user during a subsequent streaming session based on historical inputs provided by the user in prior streaming sessions. The system can compute performance impacts associated with each predicted input included within the set of possible inputs. The system also determines respective likelihoods that a particular input will occur during a subsequent streaming session. In some instances, the system can determine an optimal network traffic configuration, e.g., a configuration that minimizes the possibility of latency above a specified threshold during a streaming session, based on the predicted performance impacts and the likelihoods for the set of possible user inputs. During a streaming session, the system can monitor user inputs to determine if the user is acting in conformity with prior streaming sessions to determine whether to dynamically readjust a network configuration and/or display pre-rendered partial frames corresponding to the predicted inputs prior to detecting latency. Network configuration adjustments can include, but is not limited to, changing network routing parameters, adjusting the routing of network communication in the computing environment, adjusting the allocation and/or management of computing resources (CPU, GPU, memory) in the virtualized and/or physical computing environment, rerouting or adding computing resources in a distributed content delivery network (CDN), etc.

As another example, the system disclosed herein can predict an optimal network configuration for a streaming session based on simulating network conditions with respect to certain factors, such as a device type of the client device, a type of content to be streaming to the client device, a maximal latency for the streamed content, among others. The system uses the simulated network conditions to evaluate the impact of the factors on streaming performance during an activity streaming session.

Additionally, the system is capable of using artificial intelligence and/or machine learning techniques to perform the predictions disclosed throughout. For example, the system can include a neural network with one or more input layers representing different input data received during a streaming session, one or more hidden layers representing transformation operations for the inputs, and one or more output layers representing actions to be performed by the system during the streaming session. The neural network can be trained based on historical log data identifying, for example, user inputs received in prior streaming sessions. Once trained, the neural network can make statistical inferences relating to the likelihood of receiving similar types of inputs in a subsequent streaming session and use such inferences to identify, for example, an optimal network configuration or partial frames to represent display changes based on the predicted inputs. In other instances, the neural network can use clustering techniques to make similar predictions for groups of users or devices that are determined to be similar to one another, e.g., users that stream similar applications, device of the similar device type, etc.

Techniques described herein can provide one or more of the following technical advantages. Other advantages are discussed throughout the detailed description. The present technology can be used to dynamically predict potential performance bottlenecks in content streaming prior to, or during, a streaming session. Using the various prediction techniques disclosed herein, the system can generate customized network configurations based on a predicted activity patterns during the streaming session, e.g., applications to be used, user inputs provided, sensor data received, etc.

The system can also use the prediction techniques to reduce latencies associated with streaming content over a virtualized computing environment. For instance, the system render and/or encode frames of content using partial frames to reduce the amount of network bandwidth that is required to exchange stream data over a network. As a general example, instead of rendering and/or encoding each individual frame of the content and exchanging the frames between a host system and a computing device, the system can use predicted partial frames to render and/or encode changes between individual frames representing certain predicted user inputs. Because the amount of data that is exchanged between the host system and the computing device over the network can potentially be reduced, the overall network bandwidth associated with streaming content is also possibly reduced, thereby resulting in possible reductions latencies associated with streaming content.

As described herein, “content” or refers to any type of digital data, e.g., information stored on digital or analog storage in specific format, that is digitally broadcast, streamed, or contained in computer files for an application that is streamed from a server system to a computing device. In some instances, “content” includes passive content such as video, audio, or images that are displayed or otherwise provided to a user for viewing and/or listening. In such examples, a user provides input to access the “content” as a part of a multimedia experience. In other instances, “content” includes interactive content such as games, interactive video, audio, or images, that adjust the display and/or playback of content based on processing input provided by a user. For example, “content” can be a video stream of a game that allows a user to turn his/her head to adjust the field of view displayed to the user at any one instance, e.g., a 100-degree field of view of a 360-degree video stream. As another example, the “content” can be an application, e.g., a productivity application, which is remotely accessed by a user through a computing device and installed locally on a server system.

As described herein, “real-time” refers to information or data that is collected and/or processed instantaneously with minimal delay after the occurrence of a specified event, condition, or trigger. For instance, “real-time data” refers to data, e.g., application data, configuration data, stream data, user input data, etc., that is processed with minimal delay after a computing device collects or senses the data. The minimal delay in collecting and processing the collected data is based on a sampling rate or monitoring frequency of the computing device, and a time delay associated with processing the collected data and transmitting the processed data over a network. As an example, a server system can collect data in real-time from a computing device running a virtualized application that provides access to a streaming session, and a host system that runs an instance of a virtualized application that is accessed on the computing device through the virtualized application. In this example, the server system can process user input data from the computing device, and stream data generated by the host system in real-time. In some instances, the configuration system can dynamically adjust the stream data provided to the computing device in real-time in response to processing user input data collected on the computing device. For example, in response to receiving a user input indicating a transition between virtualized applications accessed through the virtualized application, the server system can adjust the communications between the computing device and host systems within a host system network.

As described herein, a “virtualized application” refers to an application that physically runs locally on a computing device. For example, a virtualized application can be configured to run on a computing device and provide access to a virtualized computing environment through one or more host systems within a host system network. The virtualized application can generate a display that visualizes an application instance is that is running on a host system and streamed to the computing device via a network.

As described herein, a “host system” refers to a computing device that includes physical computing hardware that runs a hypervisor and one or more virtual machines. For example, a host system can refer to a server system that is configured to operate within a distributed network of multiple host systems. The distributed network, which is referred to herein as a “host system network” can be used to, for instance, share or migrate network and/or computing resources amongst multiple host systems. As discussed below, host systems within the host system network can be configured to run applications that running on incompatible platforms.

As described herein, a “hypervisor” refers to server software that manages and runs one or more host systems as virtual machines. The hypervisor enables the host systems to run operating systems that can be different from the operating system running on a computing device that accesses the virtual machines.

As described herein, a “virtual computing environment” refers to an operating system with applications that can be remotely run and utilized by a user through a virtualized application. As discussed below, a virtual computing environment can be provisioned by establishing a network-based communication between a computing device and a host system running a virtual machine. In this example, the computing device can run a virtualized application that provides remote access to one or more virtualized applications running on the host system within a virtual computing environment.

As described herein, a “virtualized application” refers to an application that runs locally on a host system and accessed and/or controlled remotely over a network through a virtualized application running on a computing device. For example, a display of a virtualized application can be visualized through an interface of the virtualized application to provide the illusion that the virtualized application is running locally on the computing device. As discussed below, virtualized applications can refer to applications that run on different platforms, such as applications that run on different operating systems, applications that have different hardware requirements, and applications that are associated with different content provisioning platforms, among others.

As described herein, “interactive control” of a content item refers to manipulation of a content item to allow user interaction through a virtualized computing environment. For example, a user can interactively control a video game that is streamed to a remote computing device by providing input data on the remote computing device, which is then transmitted to a host system that receives the input data and manipulates the video game based on the input data. In this example, if a user provides input to adjust a field of view of a video stream, then the input can be used to adjust the field of view that is visible on the video stream.

As described herein, a “partial frame” refers to a portion of a full frame, e.g., a subset of pixels from the pixels that compose a full frame. In some instances, a “partial frame” includes a collection of pixels, e.g., a rectangular array of pixels from a larger array of pixels of the full frame. In other instances, a “partial frame” is represented as an array of pixels of an arbitrary shape, e.g., circle, triangle, based on designated objects within the full frame. For example, a “partial frame” for a “crosshair object” within a frame for a first person shooting game are the pixels that collectively represent the “crosshair object.” In this regard, a shape of a “partial frame” can be dynamically determined based on graphical elements and/or objects that are present within the full frame. A “partial frame” can also represent changes to pixels (i.e. positive and/or negative numbers that are added to color model values or other representations of pixel colors). For example, a “partial frame” can represent changes to RGB or YUV pixel values.

Additionally, individual “partial frames” can be associated with one another to generate partial video segments. A partial video segment can represent, for example, movement of a graphical element that is displayed within content, or a change to an appearance of a graphical element. As discussed below, the system described herein is capable of generating a partial video segment to represent a predicted change in the display of the content. The predicted change can be based on various factors, including user input provided by the user. For example, if the system determines, based on received user input data, that a user is likely to move a “crosshair object” toward the left side of a display of the content, then a stored partial video segment that represents this change can be selected and rendered along with the content. In other instances, a partial video segment can represent a previously rendered adjustment to display of the content. In such instances, the partial video segment is generated when the system first renders the adjustment, and then stores the partial video segment for display when the same (or similar) adjustment is subsequently displayed. For example, a partial video segment can be generated for the visual change to a menu item after user selection such that during a subsequent streaming session, the partial video segment is rendered to represent the selection of the same menu item (at a later time point).

Other versions include corresponding systems, and computer programs, configured to perform the actions of the methods encoded on computer storage devices.

The details of one or more implementations are set forth in the accompanying drawings and the description below. Other potential features and advantages will become apparent from the description, the drawings, and the claims.

Other implementations of these aspects include corresponding systems, apparatus and computer programs, configured to perform the actions of the methods, encoded on computer storage devices.

### BRIEF DESCRIPTION OF THE DRAWINGS

FIG. 1 is a schematic diagram that illustrates an example of a system that may be used to perform the prediction techniques disclosed herein.

FIGS. 2A-B are schematic diagrams that illustrate examples of techniques for predicting user inputs during a streaming session.

FIG. 3 is a schematic diagram that illustrates an example of a neural network that can be used to make dynamic predictions for interactive content streaming.

FIG. 4 is a flowchart that illustrates an example of a process for displaying pre-rendered frames corresponding to predicting user inputs to improve interactive streaming performance.

FIG. 5 is a flowchart that illustrates an example of a process for predicting frames that are likely to be rendered during a streaming session.

FIG. 6 illustrates a schematic diagram of a computer system that may be applied to any of the computer-implemented methods and other techniques described herein.

In the drawings, like reference numbers represent corresponding parts throughout.

### DETAILED DESCRIPTION

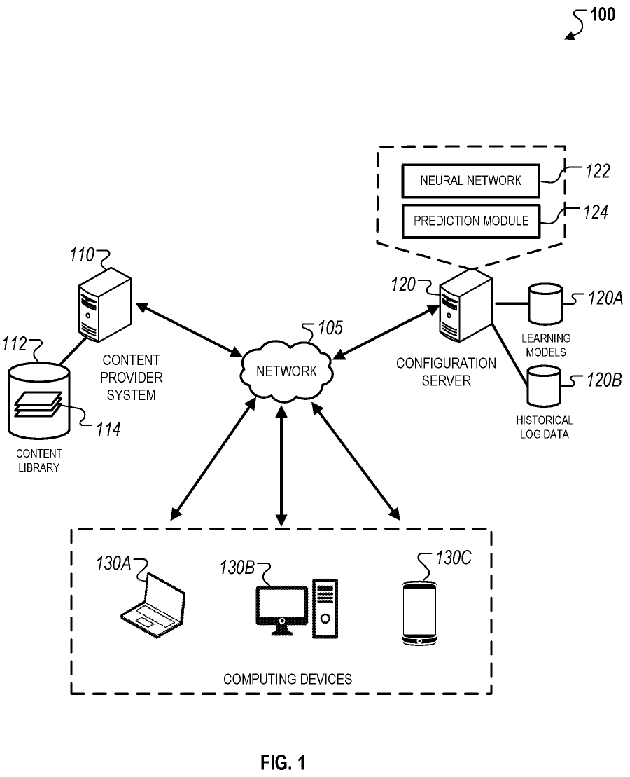

FIG. 1 is a schematic diagram that illustrates an example of a system 100 that may be used to perform the prediction techniques disclosed herein. In the example, the system 100 includes a content provider system 110, a server system 120, and computing devices 130A, 1306, and 130C connected over a network 105. The content provider system 110 stores a content library 112 with content 114. The server system 120 includes a neural network 122, a prediction module 124, and, in some instances, a graphic processing unit (not shown in FIG. 1). The server system 120 stores learning models 120A and historical log data 120B, as discussed in detail below.

The system 100 generally employs various types of prediction techniques to improve performance during a streaming session. As one example, the system 100 predicts inputs that are likely to be provided by a user during a streaming session and pre-renders partial frames corresponding to the predicted inputs. In this example, the pre-rendered partial frames can be stored in advance, e.g., remotely on the server system 120 or locally on the computing devices 130A-C, such that the pre-rendered frames can be displayed without significant rendering or encoding by a graphics processing unit. As other examples, the system 100 can predict network traffic conditions during a streaming session, sensor data to be collected by the computing devices 130A-C, or other types of actions during a streaming session. In this regard, the system 100 uses the predictions to reduce latency associated with interactive streaming by performing certain actions that are likely to occur during an streaming session in advance instead of performing the actions in real-time during the streaming session.

Referring now to the components of the system 100, the network 105 can be any type of network, including any combination of an Ethernet-based local area network (LAN), wide area network (WAN), a wireless LAN, and the Internet. The server system 120 may also include at least one processor (not shown) that obtains instructions via a bus from main memory. The processor can be any processor adapted to support the techniques described throughout. The main memory may be any memory sufficiently large to hold the necessary programs and data structures. For instance, the main memory may be one or a combination of memory devices, including Random Access Memory (RAM), nonvolatile or backup memory (e.g., programmable or Flash memory, read-only memory, etc.).

The content provider system 110 can be a server system that is associated with a content provider, such as a video streaming service provider, an application content developer, or an entity that provides subscription-based software access on the computing devices 130A-C. The content provider system 110 stores a content library 112 that includes content 114 that is accessible by the computing devices over a virtual computer environment. For example, the content library 112 can include a collection of multimedia, e.g., video, audio, applications, or files that can be accessed during a streaming session established between the server system 120 and the computing devices 130A-C.

The server system 120 can be a server system that hosts and/or configures a streaming session through which the computing devices 130A-C access content 114 included in the content library 112. The server system 120 can represent any type of computing system, e.g., a network server, a media server, a home network server, etc., that are capable of performing network-enabled functions such as hosting a set of shared resources for remotely streaming a virtual instance of an application (referred throughout as a “virtualized application”). In some implementations, the server system 110A can be a host system within a host system network, e.g., a distributed computing network, that enables a virtualized computing environment over the network 105. In such implementations, the server system 120 can be configured and/or controlled by a separate configuration server that manages its operations. In other implementations, the server system 120 can operate collectively as a host system as well as a configuration server.

The server system 120 can be used to store various types of data and/or information associated with host computer systems. For instance, the server system 120 can store installation data associated with applications that are installed on the host systems within the host system network, configuration data that adjusts the performance of the host systems within the host system network during a streaming session, among other types of information. In addition, the server system 120 can also store data of the users associated with the computing devices 130A-C. For instance, the server system 120 can store user profile data that identifies a list of installed virtualized applications, network and device attributes, and other types of categorical data associated with each computing device.

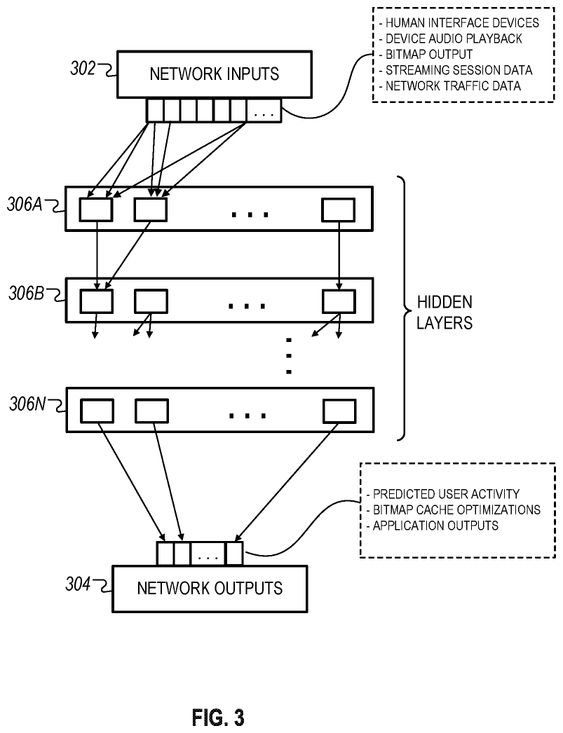

The server system 120 includes various software components that are used to execute the prediction techniques disclosed herein. The neural network 122 can be used to make predictions on conditions associated with a streaming session based on applying machine learning techniques and/or other learning techniques specified within the learning models 120A. For example, the neural network 300 depicted in FIG. 3 can be used to predict user inputs that are likely to be provided by a user during a streaming session. In other examples, the neural network 122 can make other types of predictions, such as predicted network traffic conditions during a streaming session, device actions to be performed by the computing devices 130A-C during a streaming session, or future network bandwidth utilization.

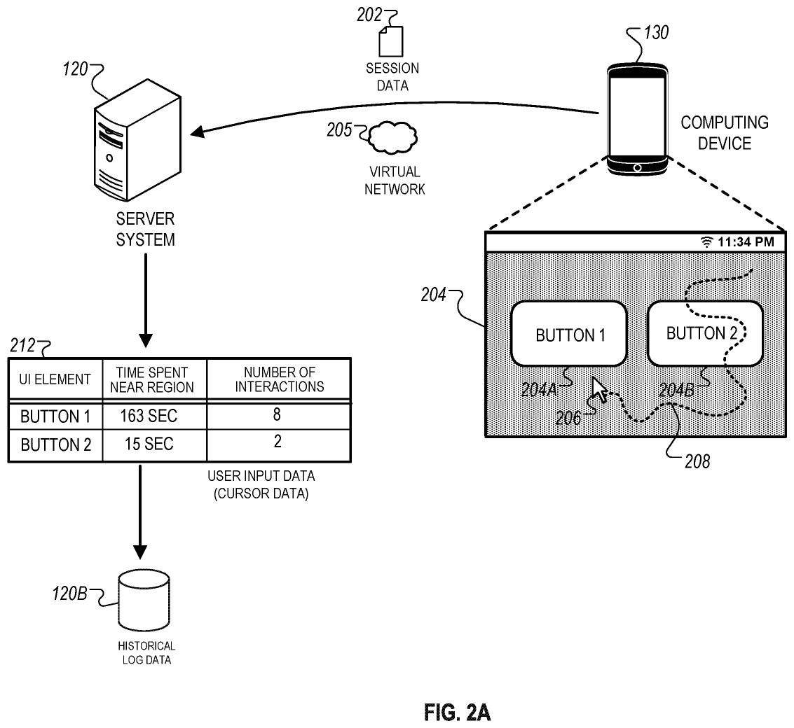

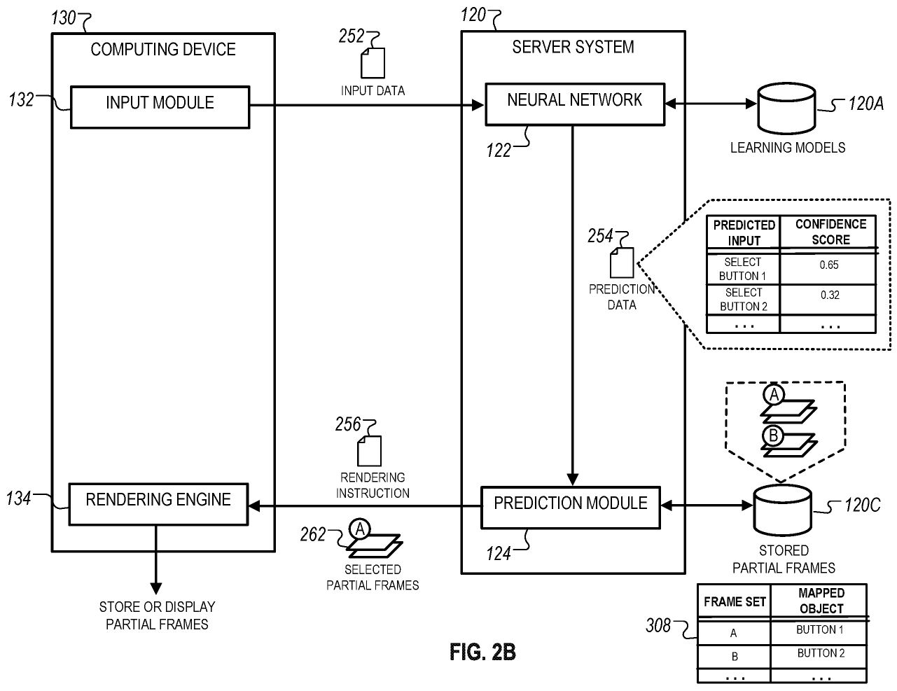

The prediction module 124 is configured to use prediction date generated by the neural network 122 to identify speculative actions to be performed by the server system 120. In the example depicted in FIG. 2B, the prediction module 124 identifies a set of pre-rendered frames corresponding to predicted user inputs that are determined by the neural network 122 to likely occur in a streaming session. In other examples, the prediction module 124 can determine simulated network configurations based on predicted network traffic conditions and prospective allocation of computing resources during a streaming session, generate speculative application configurations based on predicted application states during a streaming session, among others.

In some implementations, the server system 120 stores user profile data of users of the computing devices 130A-C. The user profile data can be used to configure remote streaming sessions between the host systems of the host system network and one of the computing devices 130A-C as it relates to streaming content. For example, when a user initiates a streaming session, user profile data can be used to dynamically fetch a list of installed applications and/or content, application data associated with each of the installed applications, and/or user-specific data such as user preferences. In this regard, user profile data can be used to enable similar remote streaming experiences between each of the host systems included within the host system network. For example, in some instances, the system may be capable of performing dynamic resource allocation such that different host systems can be used to during different remote streaming sessions of a single computing device while providing substantially similar user experiences.

The computing devices 130A-C can be any type of network-enabled electronic device that is capable of rendering a video stream received over the network 105. In the example depicted in FIG. 1, the computing device 130A is a laptop computing device, the computing device 130B is a desktop computing device, and the computing device 130C is a smartphone. In other implementations, other types of computing devices are capable of streaming content over in a similar manner as described herein. For example, the computing devices 130A-C can also include network-enabled wearable devices, such as smartwatches, fitness monitoring devices, or devices that are configured to operate with a smart home systems, e.g., a voice-enabled personal assistant device. In some instances, the computing devices 130A-C are electronic devices with limited hardware capabilities, e.g., a device without a dedicated GPU.

In some implementations, the server system 120 can implement techniques for virtual machine hypervisor forking for speculative run-ahead. For example, to determine what applications in a virtual machine may do in the future, and given possible predicted or speculative inputs, the server system 120 may fork a virtual machine hypervisor process, and run clones for short time periods, e.g., tens of milliseconds, in order to capture possible future display outputs. A process fork can be relatively lightweight, where most memory pages are made copy-on-write. While a clone is running, the server system 120 can generate speculative user inputs locally and based on predicted future user inputs by the neural network 122 as discussed in more detail below. The server system 120 can be configured to generate multiple clones and evaluate alternative speculative inputs based on resource constraints such as processor utilization and memory allocation.

In some implementations, the system 100 can be configured to make different types of speculative predictions relating to a streaming session. For example, the system 100 can make primary predictions, which refers to predictions made based on the output of the neural network 122, e.g., predicted user inputs, predicted network traffic conditions, predicted application states, etc. As discussed herein, primary predictions can be made based on different types of inputs, such as historical user inputs from prior streaming sessions, historical network traffic conditions in prior streaming sessions, prior application states, among others. Another example of inputs used for primary predictions are historical device/sensor data that is generated by computing devices 130A-C and may not be associated to user movements or actions but occur during prior streaming sessions. Historical device/sensor data can be used to predict device inputs and to pre-render frames. Yet another example of inputs are historical user-profile data that is collected by a virtual application and/or generated by computing devices 120A-C in prior streaming sessions and/or are provided in near-real-time.

The system 100 can also be configured to make secondary predictions, which refer to predictions the system executes in the process of making a primary prediction based on available input information. For example, a secondary prediction might involve predicting when the system 100 has accumulated enough input information to make a sufficiently accurate primary prediction. For instance, the system can predict that the user has not provided enough input data to make a sufficiently accurate prediction on future user inputs in subsequent streaming sessions. In such instances, the system can continue to accumulate user input data until it predicts that enough user input information is available to predict future user inputs.

As another example, a secondary prediction might involve the system executing techniques to improve quality of service management during a streaming session. In this example, the system 100 can perform network prioritization techniques, such as choice of optimal network route for packet routing, network throttling, network resource adjustment, among others. Additionally, the system 100 can prioritize certain types of network traffic, e.g., prioritizing certain type of service (ToS) bits in Internet Protocol (IP) packet headers to achieve a desired quality of service for the chosen network route. In some instances, the system 100 is capable of prioritizing the computing approach and specific resources within the content delivery network to optimize the quality of service. For example, requests can be dynamically rerouted from a current environment with low capacity to other computing resources in the content delivery network that have higher capacity to meet the demands specified by the requests.

FIGS. 2A-B are schematic diagram that illustrate examples of techniques for predicting user inputs during a streaming session. Referring initially to FIG. 2A, an example of a technique for tracking historical user activity over prior streaming sessions is depicted. In this example, the computing device 130 executes a streaming session with the server system 120 over a virtual network 205 as discussed above. The computing device 130 displays an interface 204 that enables a user to interact with user interface elements 204A and 204B. This example illustrates two user interface elements for simplicity, although other types of interfaces can also be presented to the user during a streaming session. For example, a user can stream an application, view multimedia content, execute a remote application, or access web browser over the virtual network 205.

The computing device 130 collects session data 202 during the streaming session to capture user activity and, in some instances, device data, network data, or context data associated with the streaming session. In the example depicted in FIG. 2A, the session data 202 includes cursor movement data that identifies a cursor 206 that the user uses to interact with displayed elements on the user interface 204, a cursor movement path 208 during the streaming session, and times that the cursor was placed in certain regions of the interface 204 that are associated with user interface elements, e.g., regions surrounding interface elements 204A and 204B. Once the streaming session has ended, the session data 202 is provided to the server system 120 for collection and processing.

The server system 120 processes the session data 202 to identify certain parameters that represent user activity during the streaming session. In the example depicted in FIG. 2A, the server system 120 generate a table 212 specifying interaction parameters for each interface element 204A and 204B. As shown, the table 212 specifies a time spent near a region associated with a user interface element, and a number of interactions with a user interface element, during the streaming session. In the example depicted, the table 212 reflects that the user has interacted more frequently with interface element 204A compared to interface element 204B. The data contained in the table 212 can be stored in historical log data 120B. Alternatively, if the session data is collected by the server system 120 in real-time, as the streaming session is active, then the session data 202 can be provided as input to a neural network to perform predictions, e.g., predicting user inputs that are likely to be provided by the user during the streaming session.

The historical log data 120B can be used to train the neural network 122. As described below in reference to FIG. 3, patterns within the historical log data 120B can be used to predict conditions during a subsequent streaming session. For example, user activity in prior streaming sessions, such as the information specified in table 212, can be used to predict user inputs in a subsequent streaming session.

Referring now to FIG. 2B, an example of a technique for predicting user actions during a stream session is depicted. In this example, the system performs predictions in real-time to improve performance during a streaming session as described in. In particular, the system uses user inputs received during a streaming session to predict subsequent user inputs during the streaming session. The predicted user inputs can be used to provide the computing device 130 with pre-rendered frames corresponding to the predicted inputs.

An input module 132 of the computing device 130 collects input data 252 and provides the input data 252 to the server system 120. The input module 132 can be any type of human interface device, such as a peripheral device, e.g., a keyboard and mouse, a sensor of the computing device 130, e.g., touch-enabled device, or another type of input device that is associated with the computing device 130, e.g., a head-mounted device. The input data 252 can include inputs provided by the user during a streaming session, such as keypresses, mouse clicks, and mouse movements, among others.

The server system 120 provides the input data 252 as input to the neural network 122. The neural network 122 applies learning models 120A to identify statistical patterns within the input data 252. For example, as described throughout, the neural network 122 can trained on prior session data such that it is cable of using machine learning to identify other user inputs that a user is likely to provide during the streaming session. In some instances, the neural network 122 can process the input data 252 in real-time so that predictions are made during the streaming session. In this regard, the server system 120 utilizes the predictions of the neural network 122 to identify user inputs that the computing device 130 is likely receive during the streaming session.

The neural network 122 generates prediction data 254 based on processing the input data 252 and provides prediction data 254 as output to a prediction module 124. As shown in FIG. 2B, the prediction data 254 identifies a predicted input and a confidence score assigned to each predicted input. In this example, the neural network 122 computes the confidence score to reflect the probability that a predicted input will be received during the streaming session. The confidence score assigned to the predicted input “SELECT BUTTON 1” is higher than the confidence score assigned to the predicted input “SELECT BUTTON 2,” which therefore reflects a higher probability that the user will select interface element 204A over interface element 204B as shown in FIG. 2A.

The prediction module 124 selects a set of partial frames from the stored partial frames 120C based on the prediction data 254. In the example depicted in FIG. 2B, each partial frame is mapped to an object as shown in table 308. In this example, the stored partial frames 120C represent pre-rendered frames that represent display changes once a user selects a corresponding interface element. For instance, if user selection of “BUTTON 1” results the display of a menu, then the partial frames corresponding to this object can display portions of the menu that are to be displayed to the user. In this manner, the pre-rendered frames can be provided to the computing device 130 in advance, e.g., prior to the streaming session, or during a time of limited network activity so that once a corresponding user input is received, the computing device 130 and/or the server system 120 can access and display a pre-rendered frame as opposed to generating a frame on the fly.

In the example depicted in FIG. 2B, the prediction module 124 selects only those partial frames that are identified in the prediction data 254 as having confidence scores satisfying a threshold value. For example, a threshold score of 0.6 can be used to select only those partial frames in frame set “A” that are mapped to “BUTTON 1” and not select partial frames in frame set “B” that are mapped to “BUTTON 2.” In this example, the prediction module 124 uses the prediction data 254 to determine that the user is likely to select “BUTTON 1” during the streaming session but not select “BUTTON 2.” The prediction module 124 selects partial frames 262 based on this determination and generates rendering instruction 256. The rendering instruction 256 is provided to the computing device 130 so that once the user selects “BUTTON 1,” partial frames from among the selected partial frames 262 are rendered and displayed on the computing device 130 without generating full frames on the fly. In this respect, predictions on user activity are used to determine in advance how the user will provide input at a later time during the streaming session.

The server system 120 and/or computing device 130 can use the prediction data 254 and the selected partial frames 262 to update the stream session in various ways. In some implementations, the server system 120 can render predictive inputs by forking parallel application states for the streaming session based on different predicted inputs. In such implementations, the server system 120 can copy on-write modifications, and provide each fork predictive iterations of input in then terminate clones once a prediction has been made or once a user has performed one of the predicted inputs. For example, the server system 120 can use paravirtualization to run multiple forked virtual machines that have a snapshot and copy-on write from the host operating system. Each virtual machine can run in parallel and execute predictive inputs as steps of prediction. As another example, the server system 120 can maintain a container with forked processes locked into a certain context. The server system 120 can then select a forked process corresponding a predicted input and execute the forked process in a speculative manner.

FIG. 3 is a schematic diagram that illustrates an example of a neural network 300 that can be used to make dynamic predictions for interactive content streaming. In the example depicted, the neural network 300 can be a machine-learning model that employs multiple layers of operations to predict one or more outputs from one or more inputs. The neural network 300 includes one or more hidden layers 306A, 306B, 306N that are situated between an input layer 302 and an output layer 304. The output of each layer is used as input to another layer in the network, e.g., the next hidden layer or the output layer. Each layer of the neural network 300 specifies one or more transformation operations to be performed on input to the layer. The transformation operations can involve predicting the likelihood that a certain condition will occur during a streaming session. As examples, such conditions can include the user providing a certain input, the computing device performing a certain action, the device providing a certain output, or the device collected a certain type of sensor data. In the example depicted in FIGS. 2A-B, the predicted condition relates to an input that a user is likely to provide in interacting with user interface elements presented on a display of the computing device 130.

The neural network layers have operations that are referred to as neurons. Each neuron receives one or more inputs and generates an output that is received by another neural network layer. Often, each neuron receives inputs from other neurons, and each neuron provides an output to one or more other neurons. The architecture of the neural network 300 specifies what layers are included in the network and their properties, as well as how the neurons of each layer of the network are connected. In other words, the architecture specifies which layers provide their output as input to which other layers and how the output is provided.

The transformation operations of each layer are performed by computers having installed software modules that implement the transformation operations. Thus, a layer being described as performing operations means that the computers implementing the transformation operations of the layer perform the operations.

Each layer generates one or more outputs using the current values of a set of parameters for the layer. Training the network 300 thus involves continually performing a forward pass on the input, computing gradient values, and updating the current values for the set of parameters for each layer. Once the neural network 300 is trained, the final set of parameters can be used to make predictions in a production system.

The network 300 can be a convolutional neural network. Convolutional neural network layers have one or more filters, which are defined by parameters of the layer. A convolutional neural network layer generates an output by performing a convolution of each neuron's filter with the layer's input. In addition, each convolutional network layer can have neurons in a three-dimensional arrangement, with depth, width, and height dimensions. The width and height dimensions correspond to the two-dimensional features of the layer's input. The depth dimension includes one or more depth sublayers of neurons. Generally, convolutional neural networks employ weight sharing so that all neurons in a depth sublayer have the same weights. This provides for translation invariance when detecting features in the input.

Convolutional neural networks can also include fully-connected layers and other kinds of layers. Neurons in fully-connected layers receive input from each neuron in the previous neural network layer.

In the example depicted in FIG. 3, the network 300 receives inputs based on information or data collected by the server system 200 as discussed above in FIGS. 2A-B. The input data can include user input data collected by human interface devices, such as a keyboard, mouse, or a head-mounted device. For example, the user input data can include a sequence of keypress events and their correlated timestamps (duration) since an application was launched on the computing device 130. This includes KeyUp & KeyDown (duration). As another example, the user input data can include a sequence of mouse coordinates and timestamps associated with changes in these coordinates. As yet another example, the user input data can include a sequence of head tracking coordinates and timestamps associated with changes in these coordinates.

The network 300 can also receive device actions, outputs, and data as input. For example, the network 300 can receive audio data representing the audio provided for output by the computing device 130. As another example, the network 300 can receive as input a bitmap output representing a current rendered frame captured in the form of a bitmap (or any other format) on the computing device 130. Other types of specific inputs relating to the rendering of the bitmap can also be provided as input.

The network 300 can also receive data that provides contextual information surrounding a current streaming session or prior streaming sessions. For example, the network 300 can receive network information as input in the form of unencrypted (or decryptable) network traffic from the application session in the form of bits (or any other format). This may include multiplayer person-to-person (P2P) traffic, traffic from third-party services, or any other traffic that may could cause a dynamic output during the streaming session. The network 300 can also receive the current system time, e.g., time of a virtual machine clock, virtual machine metadata representing any Metadata such as a device unique user identifier of the virtual machine or container that could later be used by an application to generate a unique output such as a random number or entropy.

The network 300 can also receive performance data relating to components of the server system 120. For example, the network 300 can receive relative capacity of the graphics processing unit, processor, and memory that may impact the ability to process requests for predictive frames. In this example, low capacity can change how many and which partial frames to deliver to the computing device 130 in response to a prediction. This variable can allow dynamic capacity monitoring across the system, which can be used to predict partial frames if the request can be dynamically rerouted from the current environment with low capacity to other computing resources in the system that have higher capacity to meet network demand. As another example, the network 300 can receive geographic location information of the server system 120 and/or the computing device 130. Location information can be a variable in determining latency and overall performance to help predict what frames can be effectively delivered. The network 300 can also use network performance as a variable in determining latency to help predict what partial frames can be effectively delivered.

In some implementations, the network 300 can be configured to receive different or additional inputs as those described above. For example, the network 300 can be tuned or adjusted by a developer to add inputs to improve the quality of predictions performed using the network 300. In some instances, the network 300 can be configured to operate with multiple developer application package interfaces (APIs) that enable, for instance, the network 300 to fetch session data at the end of a streaming session to improve upon prior predictions by using learning techniques specified within the learning models 120A.

The network 300 can be trained based on historical log data from prior sessions to identify reoccurring patterns. Training may not as latency sensitive will likely not be done offline and not during a streaming session using a tensor processing unit (TPU) or on a server system that is not in constant use, such as the server system 120. To start collecting training data, the server system can log the types of inputs discussed above on a session-by-session basis once a streaming session has ended. Session data could be anonymized and therefore dissociated from any personalized user data associated with each session. The session data can be used for routine training and updating the network 300.

The output layer 304 provides predictions that are provided as output to the server system 120. For example, the network 300 can predict a set of user inputs that a user is likely to provide during a streaming session based on transformation operations performed in the hidden layers 306A-N. If the session data is recorded in the form of video, e.g., sequences of frame, frames can avoid being rendered multiple times and can simply be displayed from a cache. The cache can contain frames which are indexed, e.g. with a hash value, and correlated to sequences of input data. This cache could be stored at the server system 120, or on the computing device 130 and used to propagate between the two based on similarity in sequence.

The output layer 304, in various implementations, can represent different types of predictions as disclosed herein. For instance, the output layer 304 can provide predicted network traffic conditions for a streaming session given inputs such as historical activity of a user, a type of application to be streamed, activities performed during the streaming session, a number of computing devices accessing a host computer network, among others. In such instances, the network 300 can process the inputs such that the output of the network 300 identifies performance bottlenecks and other constraints that are likely to affect network bandwidth during a streaming session. In other instances, the output layer 304 can provide predictions relating to computing resources of a host network for a streaming session. In such instances, the output of the network 300 can identify, for example, resource allocation amongst multiple computing devices that access the same host network for streaming services. In some other instances, the output layer 304 can be used to predict device and/or sensor actions during a streaming session. In such instances, the output of the network 300 can identify, for example, whether a computing device will run a certain application instance or access a multimedia file.

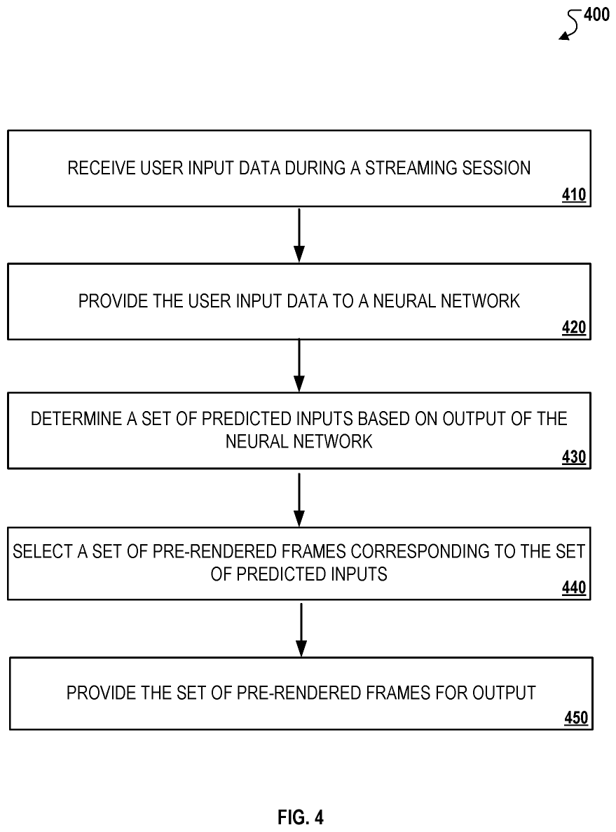

FIG. 4 is a flowchart that illustrates an example of a process 400 for displaying pre-rendered frames corresponding to predicting user inputs to improve interactive streaming performance. Briefly, the process 400 can include the operations of receiving user input data during a streaming session (410), providing the user input data to a neural network (420), determining a set of predicted inputs based on the output of the neural network (430), selecting a set of pre-rendered frames corresponding to the set of predicted inputs (440), and providing the set of pre-rendered frames for output (450).

In general, the process 400 is described below in reference to the system 100, although other types of systems that permit accessing content over a virtual computing network can perform the operations of the process 400. For example, a system that enables a user to stream content, such as applications or multimedia, from a server system to a remote client device can be configured to perform the operations of the process 400. The operations of the process 400 can be performed by a single component, such as the server system 120, or alternatively, by multiple components, such as multiple server systems that are associated with a host system network, or an associated web server. The descriptions below are in reference to the server system 120 for simplicity and brevity, although implementations where the operations are performed by other components are also contemplated.

In more detail, the process 400 can include the operation of receiving user input data during a streaming session (410). For example, the server system 120 can receive input data 252 from the computing device 130. The input data 252 can be collected by human interface devices of the computing device 130 during a streaming session between the computing device 130 and the server system 120. Examples of input data can include cursor movements, user selections of user interface elements, or other types of information that represent user interaction with content accessed during the streaming session. In some implementations, the server system 120 cam receive other types of input data, such as sensor data, device activity data, network traffic data, among others.

As discussed above in reference to FIG. 2A, the user input data can be in the historical log data 120B and used for predicting inputs in subsequent streaming sessions. Additionally, the user input data can be used to predict subsequent inputs that are likely to be received during the present streaming session as described below.

The process 400 includes the operation of providing the user input data to a neural network (420). For example, the server system 120 can provide the user input data 252 as input to the neural network 122. As discussed above, the neural network 122 can be trained to apply pattern recognition techniques to predict conditions during a streaming session given a set of input data. The neural network 122 can be trained based on patterns present within the historical log data 120B. For example, as shown in FIGS. 2A-B, the neural network 122 can use patterns associated with user inputs specified within the historical log data 120B to predict the likelihood that a user will interact with a user interface element during a subsequent streaming session. In this example, the neural network can perform statistical techniques, e.g., linear regressions, to determine whether user activity during a present streaming session is similar to user activity detected during prior streaming sessions. In other examples, the neural network 122 can predict a network traffic condition during the present streaming session based on network traffic conditions during prior similar streaming sessions. For example, network traffic conditions identified during a prior streaming session of a particular application can be used to predict the same network traffic conditions during a subsequent streaming session of the same application.

The process 400 includes the operation of determining a set of predicted inputs based on the output of the neural network (430). For example, the server system 120 can generate the prediction data 254, which identifies a set of predicted inputs based on the input data 252 for a streaming session. The set of predicted inputs can be based on applying learning models 120A to recognize patterns within the input data 252 that are similar to patterns previously identified within the historical log data 120B. For example, as discussed above, if cursor movement around a particular user interface element can be used to identify a user's interest in the user interface element based on interactions with the same user interface element in prior streaming sessions. In this examples, cursor movement can be characterized using coordinates associated with the user interface element on a user interface that is viewed by the user.

The process 400 includes the operation of selecting a set of pre-rendered frames corresponding to the set of predicted inputs (440). For example, the server system 120 can select partial frames from among the stored partial frames 120C that correspond to the inputs predicted by the neural network 122. As discussed above with respect to FIGS. 2A-2B, the partial frames can represent frames that have been pre-rendered to correspond to certain inputs provided by the user. In the example depicted in FIG. 2B, the prediction data 254 outputted by the neural network 122 indicates a high likelihood that a user will select “BUTTON 1” displayed on the interface 204. Based on this prediction, the prediction module 124 selects frameset “A” corresponding to “BUTTON 1” from the stored partial frames 120C.

The process 400 includes the operation of providing the set of pre-rendered frames for output (450). For example, the server system 120 can provide the computing device 130 with the selected partial frames 262. The server system 120 can also provide the rendering instruction 256, which, when received by the computing device 130, causes the computing device 130 to generate a display using at least one of the selected partial frames 262. In some instances, the selected partial frames 262 can be stored on the computing device 130 for a subsequent streaming session to improve performance therein.

In some implementations, the process 400 can include additional operations, such as selecting a network configuration, e.g., network parameters, allocation of computing resources, based on the output of the network 300. For example, as discussed above, the output of the neural network 300 can predict a network traffic conditions during a streaming session, which can then be used by the system 100 to determine computing resources to allocate to the computing device 130 during the streaming session. For example, if the network 300 determines that a user is likely to access a gaming application during the gaming stream, then the server system 120 can configure a host network such that a larger portion of the resources within the graphics processing unit of a host system are allocated for the computing device compared to a streaming session where the user is predicted to access only a word processing application. In this example, predicted device activity, i.e., application to be executed on the computing device, is used to dynamically configure computing resources for a streaming session prior to, or during, the streaming session and before the user access the application.

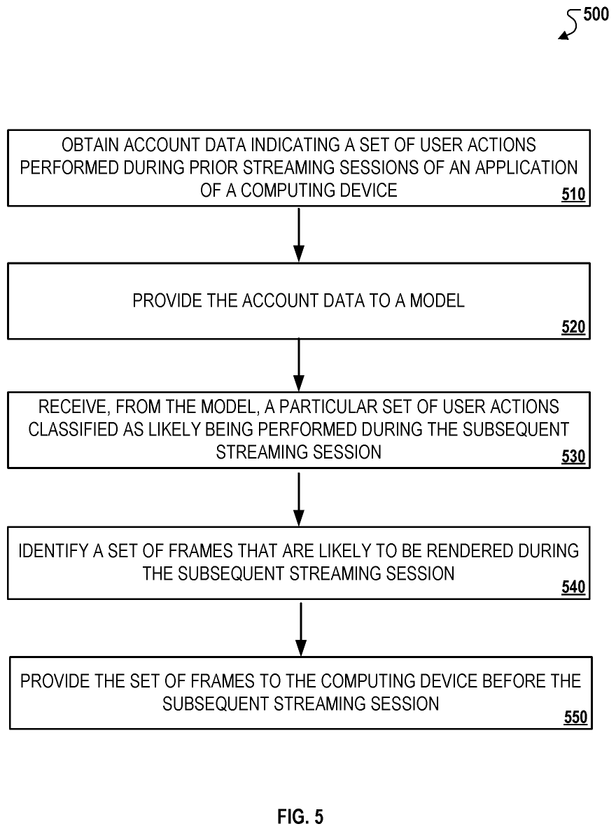

FIG. 5 is a flowchart that illustrates an example of a process 500 for predicting frames that are likely to be rendered during a streaming session. Briefly, the process 500 can include the operations of obtaining account data for prior streaming sessions of an application of a computing device (510), providing the account data to a model (520), receiving, from the model, a particular set of user actions classified as likely being performed during a subsequent streaming session (530), identifying a set of frames that are likely to be rendered during the subsequent streaming session (540), and providing the set of frames to the computing device before the subsequent streaming session (550).

In general, the process 500 is described below in reference to the system 100, although other types of systems that permit accessing content over a virtual computing network can perform the operations of the process 500. For example, a system that enables a user to stream content, such as applications or multimedia, from a server system to a remote client device can be configured to perform the operations of the process 500. The operations of the process 500 can be performed by a single component, such as the server system 120, or alternatively, by multiple components, such as multiple server systems that are associated with a host system network, or an associated web server. The descriptions below are in reference to the server system 120 for simplicity and brevity, although implementations where the operations are performed by other components are also contemplated.

In more detail, the process 500 can include the operation of obtaining account data for prior streaming sessions of an application of a computing device (510). For example, the server system 120 can obtain account data for prior streaming sessions of a virtualized application that configured to execute on the computing device 130. The account data can indicate a set of user actions performed during the prior streaming sessions. For example, as shown in FIG. 2A, the user actions can represent interactions with interface elements (e.g., buttons 204A, 204B) that are displayed through the application during the prior streaming session.

In other examples, the account data can include usage statistics associated with the user actions, such as cursor tracking data (e.g., an amount of time spent a user's cursor is within a specified proximity to a region of interest), mouse tracking data (e.g., movement of a mouse on a display), a number of times a certain action was performed (e.g., a number of times a user paused a game during a streaming session, a number of times a user accessed a particular interface of an application), among other types of data representing user behaviors during the streaming session.

The process 500 can include the operation of providing the account data to a model (520). For example, the server system 120 can provide the account data received in step 510 to a model that this trained to predict, for each of different sets of user actions, predicted user actions classified as likely being performed in a subsequent streaming session of the application on the computing device. For example, the model can be the neural network 122, which is trained to apply learning models 120A to identify patterns within the account data and thereby predict the user actions likely to be performed in the subsequent streaming session. In some implementations, the model can be a convolutional neural network with one or more input layers, one of more hidden layers, and one of more output layers, that each include multiple nodes that are configured to develop a statistical inference on the input data received by the model.

The process 500 can include the operation of receiving, from the model, a particular set of user actions classified as likely being performed during a subsequent streaming session (530). The model can be a neural network that identifies user actions likely to be performed during the subsequent streaming session. For example, as discussed above in reference to the examples depicted to FIGS. 2A and 2B, the neural network 122 can classify the input “SELECT BUTTON 1” as being classified as likely to be performed in the streaming session. This classification can be based on cursor tracking data indicates that the user has selected “BUTTON 1” in prior streaming sessions and/or the user tending to move his/her cursor such that more time is spent in a region of the user interface 204 corresponding to “BUTTON 1” (depicted in FIG. 2A). In other instances, the classification can be based on the relative frequencies of different actions being performed by the user during prior streaming sessions. For example, if the user most often accesses a certain application, such as a gaming application, then frames associated with the certain application can be classified as likely to be displayed during a subsequent streaming session.

The process 500 can include the operation of identifying a set of frames that are likely to be rendered during the subsequent streaming session (540). For example, the server system 120 can identify a set of frames that are likely to be rendered based on the set of user actions classified as likely being performed in the subsequent streaming session. In the example depicted in FIG. 2B, the frames are partial frames that represent a portion of a frame representing a visual change corresponding to a designated user action. In this example, each frame included in the stored partial frames 120C is mapped to an object that is associated with an interface element. As shown in FIG. 2B, the prediction data 254 generated by the neural network 122 indicates that “BUTTON 1” has a higher likelihood of being selected by the user during a subsequent streaming session than “BUTTON 2.” The prediction module 124 selects partial frames 262 from frame set “A” based on the association between frames in this frame set and the mapped object (i.e., “BUTTON 1”).

The process 500 can include the operation of providing the set of frames to the computing device before the subsequent streaming session (550). For example, the server system 120 can provide the set of frames to the computing device 130 for storage in a non-volatile memory. In some instances, the set of frames can be stored as a collection of pre-fetched (or pre-rendered) frames that are stored in association with application data for the virtualized application. In such instances, when a user initiates a streaming session through the virtualized applications, the rendering engine 134 can have access to the pre-fetched frames so that corresponding frames need not be rendered during the streaming session. In this way, the rendering engine 134 can use the pre-fetched frames in displaying content in lieu of rendering frames for the content dynamically during the streaming session, which can then be used to reduce latency associated with the streaming session.

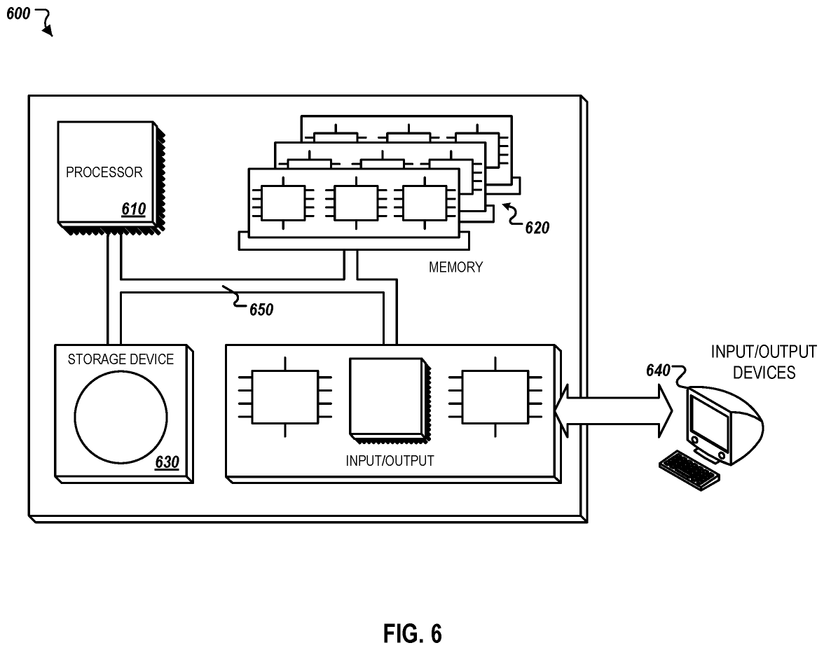

FIG. 6 is a schematic diagram of a computer system 600. The system 600 can be used to carry out the operations described in association with any of the computer-implemented methods described previously, according to some implementations. In some implementations, computing systems and devices and the functional operations described in this specification can be implemented in digital electronic circuitry, in tangibly-embodied computer software or firmware, in computer hardware, including the structures disclosed in this specification (e.g., system 600) and their structural equivalents, or in combinations of one or more of them. The system 600 is intended to include various forms of digital computers, such as laptops, desktops, workstations, personal digital assistants, servers, blade servers, mainframes, and other appropriate computers, including vehicles installed on base units or pod units of modular vehicles. The system 600 can also include mobile devices, such as personal digital assistants, cellular telephones, smartphones, and other similar computing devices. Additionally, the system can include portable storage media, such as, Universal Serial Bus (USB) flash drives. For example, the USB flash drives may store operating systems and other applications. The USB flash drives can include input/output components, such as a wireless transmitter or USB connector that may be inserted into a USB port of another computing device.

The system 600 includes a processor 610, a memory 620, a storage device 630, and an input/output device 640. Each of the components 610, 620, 630, and 640 are interconnected using a system bus 640. The processor 610 is capable of processing instructions for execution within the system 600. The processor may be designed using any of a number of architectures. For example, the processor 610 may be a CISC (Complex Instruction Set Computers) processor, a RISC (Reduced Instruction Set Computer) processor, or a MISC (Minimal Instruction Set Computer) processor.

In one implementation, the processor 610 is a single-threaded processor. In another implementation, the processor 610 is a multi-threaded processor. The processor 610 is capable of processing instructions stored in the memory 620 or on the storage device 630 to display graphical information for a user interface on the input/output device 640.

The memory 620 stores information within the system 600. In one implementation, the memory 620 is a computer-readable medium. In one implementation, the memory 620 is a volatile memory unit. In another implementation, the memory 620 is a non-volatile memory unit.

The storage device 630 is capable of providing mass storage for the system 600. In one implementation, the storage device 630 is a computer-readable medium. In various different implementations, the storage device 630 may be a floppy disk device, a hard disk device, an optical disk device, or a tape device.

The input/output device 640 provides input/output operations for the system 600. In one implementation, the input/output device 640 includes a keyboard and/or pointing device. In another implementation, the input/output device 640 includes a display unit for displaying graphical user interfaces.

Various implementations of the systems and methods described here can be realized in digital electronic circuitry, integrated circuitry, specially designed ASICs (application specific integrated circuits), computer hardware, firmware, software, and/or combinations of such implementations. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device, e.g., magnetic discs, optical disks, memory, Programmable Logic Devices (PLDs), used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here can be implemented on a computer having a display device, e.g., a CRT (cathode ray tube) or LCD (liquid crystal display) monitor for displaying information to the user and a keyboard and a pointing device, e.g., a mouse or a trackball by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

The systems and techniques described here can be implemented in a computing system that includes a back end component, e.g., as a data server, or that includes a middleware component, e.g., an server system, or that includes a front end component, e.g., a client computer having a graphical user interface or a Web browser through which a user can interact with an implementation of the systems and techniques described here, or any combination of such back end, middleware, or front end components. The components of the system can be interconnected by any form or medium of digital data communication, e.g., a communication network. Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other.

A number of embodiments have been described. Nevertheless, it will be understood that various modifications may be made without departing from the spirit and scope of the invention. In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other embodiments are within the scope of the following claims.

It should be understood that processor as used herein means one or more processing units (e.g., in a multi-core configuration). The term processing unit, as used herein, refers to microprocessors, microcontrollers, reduced instruction set circuits (RISC), application specific integrated circuits (ASIC), logic circuits, and any other circuit or device capable of executing instructions to perform functions described herein.

It should be understood that references to memory mean one or more devices operable to enable information such as processor-executable instructions and/or other data to be stored and/or retrieved. Memory may include one or more computer readable media, such as, without limitation, hard disk storage, optical drive/disk storage, removable disk storage, flash memory, non-volatile memory, ROM, EEPROM, random access memory (RAM), and the like.

Additionally, it should be understood that communicatively coupled components may be in communication through being integrated on the same printed circuit board (PCB), in communication through a bus, through shared memory, through a wired or wireless data communication network, and/or other means of data communication. Additionally, it should be understood that data communication networks referred to herein may be implemented using Transport Control Protocol/Internet Protocol (TCP/IP), User Datagram Protocol (UDP), or the like, and the underlying connections may comprise wired connections and corresponding protocols, for example, Institute of Electrical and Electronics Engineers (IEEE) 802.3 and/or wireless connections and associated protocols, for example, an IEEE 802.11 protocol, an IEEE 802.15 protocol, and/or an IEEE 802.16 protocol.

A technical effect of systems and methods described herein includes at least one of: (a) increased accuracy in facial matching systems; (b) reduction of false accept rate (FAR) in facial matching; (c) increased speed of facial matching.

Although specific features of various implementations of the invention may be shown in some drawings and not in others, this is for convenience only. In accordance with the principles of the invention, any feature of a drawing may be referenced and/or claimed in combination with any feature of any other drawing.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

1. A system comprising:
one or more computers; and
one or more storage devices storing instructions that, when executed by the one or more computers, cause the one or more computers to perform operations comprising:
obtaining account data indicating a set of user actions performed during prior streaming sessions of an application of a computing device;
providing the account data to a model that is trained to output, for each of different sets of user actions, predicted user actions classified as likely being performed in a subsequent streaming session of the application on the computing device;
receiving, from the model, a particular set of user actions classified as likely being performed during the subsequent streaming session;
identifying, based on the particular set of user actions classified as likely being performed in the subsequent streaming session, a set of frames that are likely to be rendered during the subsequent streaming session; and
providing the set of frames to the computing device before the subsequent streaming session.

2. The system of claim 1, wherein:
the set of user actions indicates user inputs received through an input interface of the computing device during the prior streaming sessions of the application; and
the set of predicted user actions indicates user inputs likely to be received through the input interface of the computing device during the subsequent streaming session of the application.

3. The system of claim 2, wherein the user inputs likely to be received through the input interface of the computing device comprises a user input indicating selection of a user interface element displayed on an interface of the application during the subsequent streaming session.

4. The system of claim 1, wherein identifying the set of frames that are likely to be rendered during the subsequent streaming session comprises:
identifying a collection of frames, wherein each frame included in the collection of frames (i) represents a different type of visual change to an interface of the application during a streaming session, and (ii) is associated with a distinct user input received on the computing device during the streaming session; and
identifying the set of frames that are likely to be rendered during the subsequent streaming session by selecting a subset of frames from among the collection of frames based on the particular set of user actions classified as likely being performed in the subsequent streaming session.

5. The system of claim 1, wherein:
the set of frames comprises one or more partial frames; and
each of the one or more partial frames is mapped to a different interface element that is likely to be displayed on an interface of the application during the subsequent streaming session.

6. The system of claim 1, wherein the operations further comprise:
before the subsequent streaming session, providing, to the computing device, an instruction that, when received by the computing device, causes the computing device to store the set of frames as pre-fetched frames in a non-volatile storage medium associated with the computing device.

7. The system of claim 6, wherein the instruction:
includes an assignment of a particular user action to each frame included in the set of frames, a set of user actions; and
causes the computing device to display a corresponding user action based on determining that the corresponding user action has been detected during the subsequent streaming session.

8. The system of claim 1, wherein the model comprises a convolutional neural network.

9. A method comprising:
obtaining account data indicating a set of user actions performed during prior streaming sessions of an application of a computing device;
providing the account data to a model that is trained to output, for each of different sets of user actions, predicted user actions classified as likely being performed in a subsequent streaming session of the application on the computing device;
receiving, from the model, a particular set of user actions classified as likely being performed during the subsequent streaming session;
identifying, based on the particular set of user actions classified as likely being performed in the subsequent streaming session, a set of frames that are likely to be rendered during the subsequent streaming session; and
providing the set of frames to the computing device before the subsequent streaming session.

10. The method of claim 9, wherein:
the set of user actions indicates user inputs received through an input interface of the computing device during the prior streaming sessions of the application; and
the set of predicted user actions indicates user inputs likely to be received through the input interface of the computing device during the subsequent streaming session of the application.

11. The method of claim 10, wherein the user inputs likely to be received through the input interface of the computing device comprises a user input indicating selection of a user interface element displayed on an interface of the application during the subsequent streaming session.

12. The method of claim 9, wherein identifying the set of frames that are likely to be rendered during the subsequent streaming session comprises:
identifying a collection of frames, wherein each frame included in the collection of frames (i) represents a different type of visual change to an interface of the application during a streaming session, and (ii) is associated with a distinct user input received on the computing device during the streaming session; and
identifying the set of frames that are likely to be rendered during the subsequent streaming session by selecting a subset of frames from among the collection of frames based on the particular set of user actions classified as likely being performed in the subsequent streaming session.

13. The method of claim 9, wherein:
the set of frames comprises one or more partial frames; and
each of the one or more partial frames is mapped to a different interface element that is likely to be displayed on an interface of the application during the subsequent streaming session.

14. The method of claim 9, further comprising:
before the subsequent streaming session, providing, to the computing device, an instruction that, when received by the computing device, causes the computing device to store the set of frames as pre-fetched frames in a non-volatile storage medium associated with the computing device.

15. The method of claim 14, wherein the instruction:
Includes an assignment of a particular user action to each frame included in the set of frames, a set of user actions; and
causes the computing device to display a corresponding user action based on determining that the corresponding user action has been detected during the subsequent streaming session.

16. One or more non-transitory computer-readable storage media encoded with computer program instructions that, when executed by one or more computers, cause the one or more computers to perform operations comprising:
obtaining account data indicating a set of user actions performed during prior streaming sessions of an application of a computing device;
providing the account data to a model that is trained to output, for each of different sets of user actions, predicted user actions classified as likely being performed in a subsequent streaming session of the application on the computing device;
receiving, from the model, a particular set of user actions classified as likely being performed during the subsequent streaming session;
identifying, based on the particular set of user actions classified as likely being performed in the subsequent streaming session, a set of frames that are likely to be rendered during the subsequent streaming session; and
providing the set of frames to the computing device before the subsequent streaming session.

17. The device of claim 16, wherein:
the set of user actions indicates user inputs received through an input interface of the computing device during the prior streaming sessions of the application; and
the set of predicted user actions indicates user inputs likely to be received through the input interface of the computing device during the subsequent streaming session of the application.

18. The device of claim 17, wherein the user inputs likely to be received through the input interface of the computing device comprises a user input indicating selection of a user interface element displayed on an interface of the application during the subsequent streaming session.

19. The device of claim 16, wherein identifying the set of frames that are likely to be rendered during the subsequent streaming session comprises:
identifying a collection of frames, wherein each frame included in the collection of frames (i) represents a different type of visual change to an interface of the application during a streaming session, and (ii) is associated with a distinct user input received on the computing device during the streaming session; and
identifying the set of frames that are likely to be rendered during the subsequent streaming session by selecting a subset of frames from among the collection of frames based on the particular set of user actions classified as likely being performed in the subsequent streaming session.

20. The device of claim 16, wherein:
the set of frames comprises one or more partial frames; and
each of the one or more partial frames is mapped to a different interface element that is likely to be displayed on an interface of the application during the subsequent streaming session.
